(19) United States
(12) Patent Application Publication
(10) Pub. No.: US 2026/0169529 A1
(43) Pub. Date: Jun. 18, 2026

(54) PIVOT, PROCESS FOR MANUFACTURING SUCH A PIVOT, OSCILLATOR COMPRISING SUCH A PIVOT, WATCH MOVEMENT AND TIMEPIECE COMPRISING SUCH AN OSCILLATOR

(71) Applicant: ECOLE POLYTECHNIQUE FEDERALE DE LAUSANNE (EPFL), Lausanne (CH)

(72) Inventors: Loïc TISSOT-DAGUETTE, Yverdon-les-Bains (CH); Simon HENEIN, NEUCHATEL (CH)

(73) Assignee: ECOLE POLYTECHNIQUE FEDERALE DE LAUSANNE (EPFL), Lausanne (CH)

(21) Appl. No.: 19/128,619

(22) PCT Filed: Nov. 9, 2023
(86) PCT No.: PCT/IB2023/061333

§ 371 Date: May 9, 2025

(30) Foreign Application Priority Data
Nov. 9, 2022 (EP) 22206404.0

(51) Int. Cl. G06F 1/16; G04B 17/04

(52) U.S. Cl. CPC G06F 1/1679; G04B 17/045; G06F 1/1681

(57) ABSTRACT

A pivot comprising a central assembly (401) and a peripheral assembly (400). The two assemblies are mobile in rotation relative to each other around an axis of rotation (A). The central assembly (401) is kinematically connected to the peripheral assembly (400) by at least three connecting rods (402, 403, 404), and the connecting rods are each connected to an arm (405, 406, 407). The arms are connected to the peripheral assembly so that the arm can pivot around a pivoting point (408, 409, 410). The connecting rods are connected to the arms in a location different from the pivoting point. Moreover, at least two pairs of arms are connected together by a coupling link (411, 412, 413) in a location different from the pivoting point. A process for manufacturing such a pivot, an oscillator, a watch movement comprising an oscillator and a timepiece comprising such an oscillator are also disclosed.

### TECHNICAL FIELD

The present invention relates to the field of mechanics and in particular to the field of pivots. More specifically, the invention concerns a pivot comprising two assemblies, namely a central assembly and a peripheral assembly, these two assemblies being mobile in rotation relative to each other around an axis of rotation.

The invention further concerns a process for manufacturing such a pivot.

The invention also concerns an oscillator comprising such a pivot, as well as a watch movement and a timepiece comprising such an oscillator.

### PRIOR ART

Pivots are used in a wide range of mechanical applications. In some applications where high precision is required, it is very important that the pivot exhibits a motion of the rotating assembly that is as close as possible to a pure rotation. Indeed, several of the known pivots exhibits parasitic translations in addition to the desired rotational motion. This defect is generally quantified by measuring the parasitic shift of the pivot, which is the displacement of a point belonging to the rotating assembly of the pivot, the said point lying on the initial rotation axis of the pivot, as a function of the rotating angle. Another equivalent means for quantifying the rotation motion defect of pivots is to measure the displacement of the instantaneous center of rotation of the pivot as a function of the rotation angle. Both the parasitic shift and the displacement of the instantaneous center of rotation should be reduced as much as possible or set to zero if possible.

Depending on the application, it is also important that the radial stiffness of the pivot is as high as possible. Thus, the movement of the pivot does not depend on its position or orientation and in particular, its displacement characteristics such as amplitude or frequency are independent on its position with respect to gravity. Moreover, the high stiffness avoids mechanical deformation of the pivot caused by constraints applied to this pivot.

In some applications, the pivot is a flexure pivot, i.e., a pivot which exhibits an elastic restoring torque or force. In such an application, when the flexible pivot is rotated out of its rest position, the restoring force tends to bring the pivot back to this rest position. Such a pivot can in particular be used as a time base or an oscillator for example for a timepiece. In such an application, the isochronism is important. This means that the frequency of the oscillation must not depend on the amplitude of the movement and must remain constant for any rotation amplitude.

In watch industry, flexure pivots have become an interesting replacement of traditional hairspring-balance wheel oscillators used in timepieces as they provide both a restoring torque and a guided rotation of the balance. Furthermore, since the rotation guidance of flexure pivot oscillators exhibits no solid friction, they usually have a higher quality factor compared to bearing-based oscillators. Less energy is then required to maintain the oscillation and the chronometric performance is enhanced.

One first challenge of such flexure pivot oscillators is to maintain the same oscillation frequency for any orientation of the system relative to Earth's gravity. A common approach is to design a flexure pivot whose parasitic shift during its rotation is zero. If, in addition, the center of mass of the rotating balance coincides with the axis of rotation, then the restoring torque is consequently not affected by gravity.

Patent EP2911012B1 presents a flexure pivot consisting of perpendicularly crossed blades connecting the timepiece support element to the balance to obtain a rotary oscillator. To minimize the parasitic shift of the balance during its rotation, the blades are placed in different planes and their intersection axis coincides at ˜⅛ of their respective length.

These crossed flexure pivots exhibit a nonlinear restoring torque which creates an isochronism defect, i.e., the oscillation frequency is dependent of the oscillation amplitude, reducing the timepiece accuracy.

U.S. Pat. No. 8,672,536B2 proposes to add a flexure component, called isochronous corrector, to compensate the isochronism defect. However, this additional component introduces shocks and solid friction to the oscillator which can perturbate its oscillation.

Alternatively, patent application WO2016096677A1 proposes to cross the blades with an angle different than 90° to optimize the isochronism of crossed flexure pivots. Indeed, the authors demonstrated that a crossing angle between 68° et 76°, and more preferably equal to 71.2°, provides a linear restoring torque without affecting the gravity insensitivity of the pivot. Nevertheless, these oscillators have a weak transversal stiffness and are therefore very sensitive to shocks and vibrations.

Patent EP3382470B1 proposes the design of a flexure pivot with multiple perpendicular crossing blades to keep a high transversal stiffness, but with slightly shifted crossing axes to linearize the restoring torque.

All the above presented inventions require manufacturing 3D structures which is not always feasible with current technology processes.

The patent application WO2020016131A1 presents a planar flexure pivot partially sensitive to gravity and with intrinsically tuned isochronism. Even if its 2D structure is easier to manufacture at watch scale e.g., using Deep Reactive Ion Etching of silicon substrate, the flexure pivot exhibits a non-negligible parasitic motion for high angular stroke and is sensible to shocks due to its low radial stiffness. It also has an inertia that varies as a function of the rotation angle, which implies a non-harmonic oscillation.

To obtain a flexure pivot with a theoretical zero parasitic shift even for high amplitudes, the patents CH717996A2, EP4047424A1, EP3992729A1, EP3476748B1 and EP3548973B1 propose flexure pivot structures with a third order rotational symmetry.

Nevertheless, their radial stiffness is low as the ratio of the radial vibration frequency on the pivot natural oscillation frequency is low, which makes the oscillators sensible to gravity, shocks, linear accelerations or vibrations. The low radial stiffness is due to the fact that the motion of the linear stages is not efficiently transmitted by the coupling elements.

Oscillators with low radial stiffness have usually a small balance mass to reduce the radial sag and prevent radial vibrations. But a small balance mass leads to high oscillation frequencies (approximately 18 Hz for EP3548973B1 and approximately 40 Hz for WO2019156552A1). These high oscillation frequencies require the design of high-speed escapements and gear trains, increasing energy loses which can then reduce the power reserve and the accuracy of the timepiece.

Note that the out-of-plane stiffnesses are mostly dependent on the structure out-of-plane width which is manufacturing related.

In view of the above, it appears that there is a need for an oscillator exhibiting no or limited parasitic shift, high stiffness and with tunable isochronism.

### DESCRIPTION OF THE INVENTION

The present invention proposes to eliminate the disadvantages of the prior art by proposing a new pivot with one, several or all the following advantages:
the pivot can be planar to simplify the manufacturing process;
the pivot can be designed to obtain a theoretical zero parasitic shift (i.e., zero displacement of the instantaneous center of rotation). In case this pivot is used as a flexure pivot and the center of mass of the rotating balance coincides with the axis of rotation, the oscillation frequency of the flexure pivot is insensitive to the orientation of the pivot or of the timepiece in which it is integrated, with respect to the gravitational field;
the flexure pivot can have a linear restoring torque or a tuned nonlinear restoring torque to compensate for externally induced isochronism defects such as the ones introduced by escapements;
the flexure pivot can have a constant or a varying inertia with respect to its rotation angle to further tune the isochronism;
the pivot can have a high radial stiffness to be less sensitive to external accelerations such as shocks, vibrations, gravity, etc.;
the pivot can be exempt from internal degrees of freedom that can be excited by high frequency movements or external vibrations.

The advantages of the invention are obtained by a pivot as described in the preamble and wherein the central assembly is kinematically connected to the peripheral assembly by at least three connecting rods, said connecting rods being each connected to an arm, the arms being connected to said peripheral assembly by a pivotable connection so that the arm can pivot around a pivot point, the connecting rods being connected to the arms in a location different from the pivot point of said arm, and wherein at least two pairs of arms are connected together by a connecting element.

The objects of the invention are further obtained by a manufacturing process as described in the preamble and wherein said manufacturing process comprises a step of applying a stress to the material forming said flexure pivot, in order to modify the restoring torque of the flexure pivot.

The objects of the invention are also obtained by an oscillator comprising a pivot as described above and by a clock movement and a timepiece comprising at least an oscillator as described above.

### SHORT DESCRIPTION OF THE DRAWINGS

The present invention and its advantages will be better understood with reference to the enclosed drawings and to the detailed description of several embodiments, in which:

FIG. 1 schematically illustrates a pivot according to the prior art and in particular to EP 4 047 424A 1;

FIG. 2 illustrates the kinematics of a pivot according to an embodiment of the present invention;

FIG. 3 illustrates the kinematics of a variant of the pivot of FIG. 2;

FIG. 4 illustrates the kinematics of a variant of the pivot of FIG. 2, said pivot having a total rotational symmetry of third order around the center of rotation;

FIG. 5 illustrates the kinematics of a variant of the pivot of FIG. 4, having a total rotational symmetry of fourth order around the center of rotation;

FIG. 6 illustrates the kinematics of a variant of the pivot of FIG. 2, in a rest position, where the arms are placed arbitrarily around the axis of rotation;

FIG. 7 illustrates the pivot of FIG. 6, in a moved position;

FIGS. 8 and 9 are variants of the pivot of FIGS. 6 and 7, respectively;

FIG. 10 illustrates the kinematics of a variant of the pivot of FIG. 5;

FIG. 11 illustrates the kinematics of the pivot of FIG. 10, in a first position in which a moving part of the pivot is rotated through a first angle around the center of rotation;

FIG. 12 illustrates the pivot of FIG. 11, in a rest position;

FIG. 13 illustrates the pivot of FIG. 11, in a second position in which the moving part of the pivot is rotated through a second angle around the center of rotation;

FIG. 14 illustrates the kinematics of a pivot with six arms;

FIGS. 15a to 15h show different ways of concretely realizing a first flexible connection used in a flexure pivot according to the invention;

FIGS. 16a to 16f show different ways of concretely realizing a second flexible connection used in a flexure pivot according to the invention;

FIG. 17 shows an example of a concrete realization of a flexure pivot in a first deformed position, based on the principles illustrated by FIG. 4,

FIG. 18 shows the flexure pivot of FIG. 17 in a rest position;

FIG. 19 shows the flexure pivot of FIG. 17 in a second deformed position;

FIG. 20 illustrates another variant of a flexure pivot according to the present invention, in a rest position, based on the principles illustrated by FIG. 10;

FIG. 21 illustrates still another variant of a flexure pivot of the invention, based on the principles illustrated by FIG. 14;

FIG. 22 is a graph illustrating the restoring torque of the flexure pivot as a function of the rotation angle;

FIG. 23 illustrates a flexure pivot according to the invention, comprising a first embodiment of a torque adjusting element; and

FIG. 24 illustrates a flexure pivot according to the invention, comprising a second embodiment of a torque adjusting element.

### WAY OF CARRYING OUT THE INVENTION

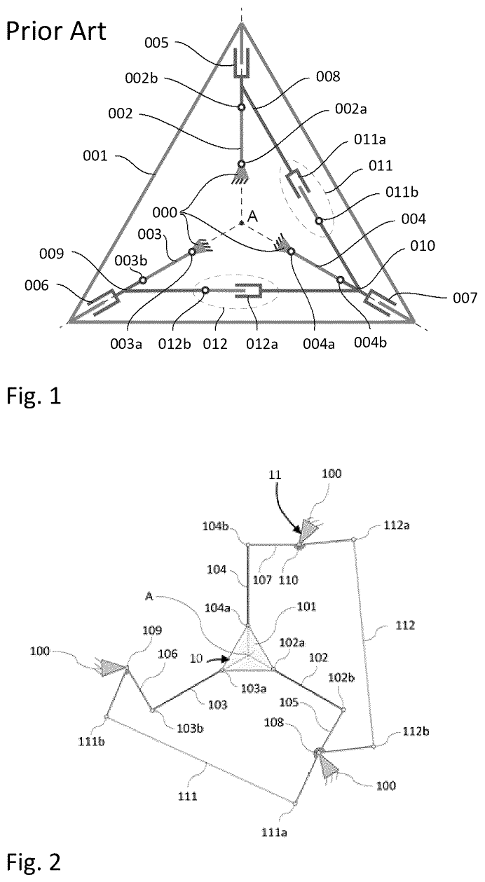

FIG. 1 illustrates the kinematics of a pivot of the prior art and in particular the flexure pivot described in the patent application EP4047424. The flexure pivot comprises sliding connections 005, 006, 007, 011a, 012a instead of pivoting or deformable connection. These sliding connections do not allow for high radial stiffness. Therefore, this pivot is sensitive to gravity, shocks, linear accelerations or vibrations.

The pivots concerned by the invention are illustrated by FIGS. 2-14, 17-21 and 23-24 and are based on two generic architectures called Type I and Type II pivots. All declinations of these architectures are based on three or more kinematic chains (n≥3) based on three serial revolute joints connecting in parallel a central assembly to a peripheral assembly. Based on these particular cases, it is straightforward to conceive other pivots of the same family having other n values.

A Type I pivot is presented at least by FIG. 6. Said pivot comprises a rigid body 101 connected via three hinges 102a, 103a, 104a to three connecting rods 102, 103, 104. These three connecting rods are connected via three hinges 102b, 103b, 104b to three arms 105, 106, 107 respectively. The three arms are connected to a peripheral assembly 100 via three hinges 108, 109, 110. The arms 105, 106, 107 are connected by pairs via a rigid coupling link 111, 112 and hinges 111a, 111b, 112a, 112b. The geometry is built around a point A called the axis of rotation.

The pivot of type I fulfils the two conditions below.
Condition 1: The quadrilaterals A-102a-102b-108-A, A-103a-103b-109-A and A-104a-104b-110-A are geometrically similar (i.e., their corresponding angles are congruent, and their corresponding sides are proportional) but not reflected.
Condition 2: The quadrilaterals 108-109-111a-111b and 109-107-112a-112b are parallelograms.

If Conditions 1 and 2 are fulfilled, Type I pivots have a single degree of freedom (DOF) which is a pure rotation of the central assembly around the axis of rotation A. It is remarkable to note that, as long as singularities are avoided:
The parasitic shift of the central assembly is zero, independently of the amplitude of the rotation;
The mechanism has no overconstraint and no internal DOF.
The center of rotation can be located outside of the mechanism volume.

Some additional geometric conditions can be added to reach interesting cases.
Condition 3: In neutral position, the lines drawn by the points having the references 108-102b and 102b-102a (respectively 109-103b and 103b-103a, and 110-104b and 104b-104a) are orthogonal. Advantage: When rotating the central assembly in the vicinity of the neutral position, the rotation amplitude of the arms tends to zero. This minimizes the motion amplitude of the hinges 108, 109 and 110.
Condition 4: In neutral position, the line segment 111b-111a is orthogonal to the segment 108-111b as well as to 109-111a (respectively 112b-112a is orthogonal to 109-112b as well as to 110-112a). Advantage: the forces transmitted through the coupling links are minimized.
Condition 5: The distances A-102a, A-103a and A-104a are equal. When combined to Condition 1, Condition 5 implies that the quadrilaterals A-102a-102b-108, A-103a-103b-109 and A-104a-104b-110 are geometrically congruent but not reflected. Advantage: symmetrical design.
Condition 6: The hinges 108, 109 and 110 are located with a rotational symmetry around the axis of rotation A. Advantage: symmetrical design.
Condition 7: The distances 108-111b and 109-112b are equal. Advantage: the coupling chains have the same proportions, which improves the symmetry of the design.

A Type I pivot satisfying all the listed conditions (1 to 7) is shown in FIG. 2.

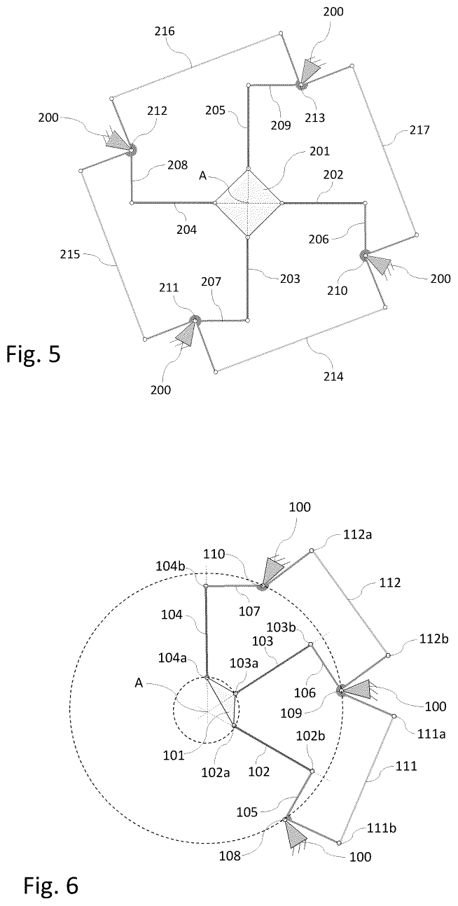

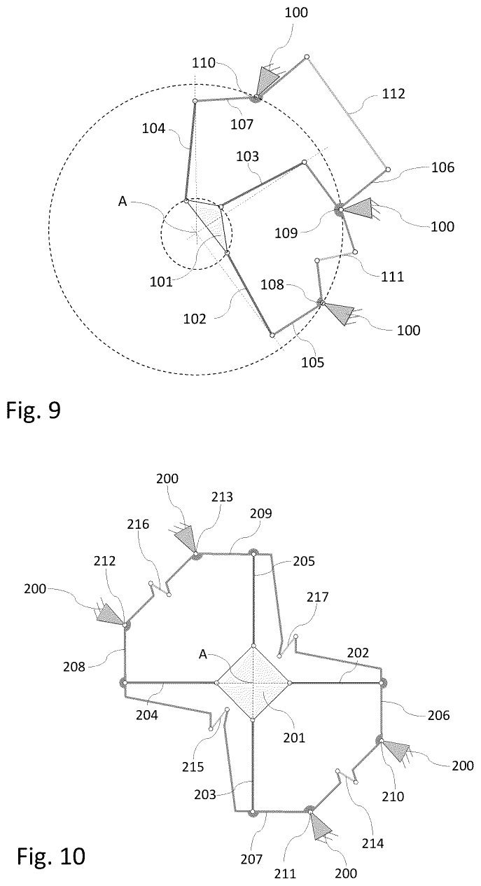

Design alternatives to Type I pivots, called Quasi-Type I pivots, where Conditions 1 and 2 are not fully respected, are presented due to their additional benefits. The considered design variants, are listed below:
Mirrored kinematic chain: Condition 1 is modified to obtain two mirrored kinematic chains. This symmetry allows the structure to obtain symmetrical behaviors when the pivot is rotated clockwise and counterclockwise. A pivot with two mirrored kinematic chains is shown in neutral position and in rotated position respectively in FIGS. 8 and 9.
Watt's linkage coupler: In order to couple two mirrored kinematic chains, Condition 2 must be modified: the parallelogram linkage coupler, i.e., formed by the quadrilaterals 108-111b-111a-109 or 109-112b-112a-110 is replaced by a Watt's linkage. This fulfills the coupling of the mirrored secondary links, forcing them to rotate with approximately equal angle magnitude, but in opposite directions. Since Conditions 1 and 2 are no longer respected, this leads to small parasitic shifts of the instant center of rotation for small rotation amplitudes. This parasitic shift is minimized if Condition 4 is respected. Note that the advantage of transmitting minimalized forces through the coupling links is also preserved with Condition 4. A pivot with a watt's linkage is shown in neutral position and in rotated position respectively in FIGS. 8 and 9.
Supernumerary kinematic chains: The number n of hinges and respective kinematic chains (n=3 in the case of Type I pivots) can be increased. This can lead to increased load capacity in out-of-plane directions. Pivots presented in FIGS. 5 and 10-14 have supernumerary kinematic chains.
Supernumerary coupling links: The number m of coupling links (m=2 in the case of Type I pivots) can be increased. Note that additional coupling links (i.e., m>2) induce overconstraints but lead to increased load capacity in radial directions. Pivots presented in FIGS. 4-5 and 10-14 have supernumerary coupling links.

Type II pivots have the same topology as Type I pivots. Condition 1 is however different: the quadrilaterals A-102a-102b-108, A-103a-103b-109 and A-104a-104b-110 are parallelograms instead of similar polygons for Type I. These parallelograms do not need to be similar, which was a constraining condition for Type I. If Condition 2 is respected, the geometric properties of Type I, namely zero parasitic shift, no under-or overconstraints, are also valid for Type II.

FIG. 2 illustrates the kinematics of a pivot represented with rigid links and ideal hinges in neutral or rest position, i.e., the structure being not deformed. The pivot comprises a central assembly 10 comprising a rotating rigid body 101 that can perform a rotation without parasitic shift around an axis of rotation A with respect to a peripheral assembly 11 comprising a support 100.

It should be noted that in the description of FIG. 2, the central assembly 10 is considered as moving around the axis of rotation A and the peripheral assembly 11 is considered as fixed. The opposite is also possible without changing the concept of the invention, i.e., the central assembly can be fixed and the peripheral assembly can rotate around the axis of rotation A.

The central assembly 10 is kinematically connected to the peripheral assembly 11 by at least three connecting rods 102, 103, 104 and three arms 105, 106, 107. More specifically, the central assembly 10 is connected to the connecting rod 102, 103, 104 by a first hinge 102a, 103a, 104a, the connecting rod 102, 103, 104 being connected to the arms 105, 106, 107 by a second hinge 102b, 103b, 104b and the arms 105, 106, 107 being connected to the peripheral assembly 11 by a third hinge 108, 109, 110.

The connecting rods and the arms are placed with a third order rotational symmetry around the axis of rotation A to support the central assembly 10 comprising the rotating rigid body 101.

The connecting rods 102, 103, 104 form first links called primary links. The arms 105, 106, 107 form links called intermediate links. To avoid translational motions of the rigid body 101 in the drawing plane, two connecting elements called coupling links 111, 112 and four ideal hinges 111a, 111b, 112a, 112b are used to couple kinematically the rotation of the arms. Indeed, the ideal hinges 108, 111a, 111b, 109 and 110, 112a, 112b, 108 form two parallelogram linkages to transmit the same rotation amplitude between the third ideal hinges 108, 109, 110.

This system is isostatic and has a single degree of freedom corresponding to the rotation of the central assembly 10 with respect to the peripheral assembly 11 or of the rotating rigid body 101 with respect to the support 100 around the axis of rotation A.

Since the coupling of pivoting levers is more efficient than linear stages with non-parallel directions, the use of the third ideal hinges 108, 109, 110 in the present invention, instead of the slide type joints 005, 006, 007 in the patent EP4047424A1 results in a higher radial stiffness of the flexure pivot.

The kinematic arrangement of FIG. 2 imposes the second hinges 102b, 103b and 104b to move concentrically. More precisely, during rotation, the points formed by the second hinges 102b, 103b and 104b remain equidistant to point A, and the triangle formed by these points remain geometrically similar (equiangular triangles). This property holds rigorously for the arrangements of FIGS. 2, 3, 4, 9 and 10.

The arrangement of FIG. 5 comprises four connecting rods 202, 203, 204, 205. Inward extremities of these connecting rods are linked to a rigid body 201. Outward extremities of the connecting rods are linked to arms 206, 207, 208, 209. For the kinematic arrangement of FIG. 5, the four points located at the outward extremities of the connecting rods 202, 203, 204 and 205 remain equidistant to A, and the square formed by these points remains a square shape during motion.

For the kinematic arrangements of FIGS. 8, 9, 10, 11, 12, 13 and 14 the points located at the outward extremities of the connecting rods remain equidistant to A, but the polygons formed by these points do not remain precisely geometrically similar (congruent angles) during motion, which leads to residual parasitic shifts if the structure is not symmetrical in rotation around A.

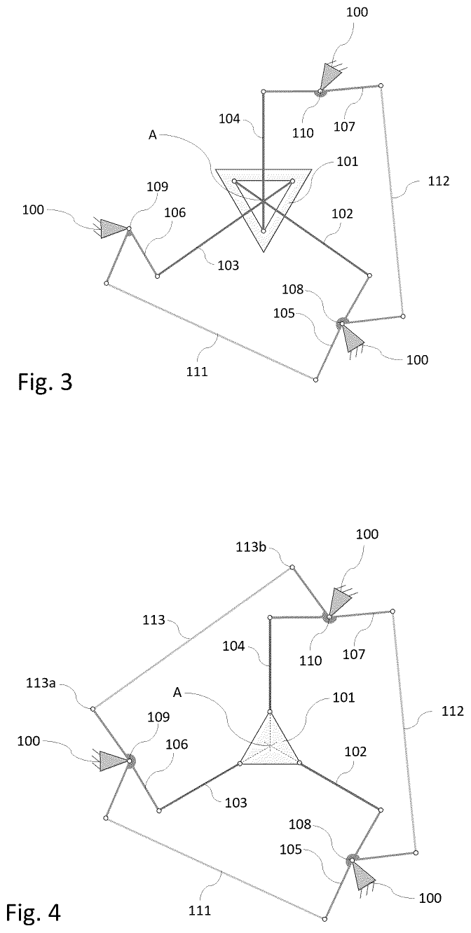

FIG. 3 illustrates the kinematics of a pivot as in FIG. 2 but where the connecting rods 102, 103, 104 forming the primary links cross each other in different planes. The axis of rotation A of the rotating rigid body 101 still corresponds to the intersection point of the connecting rods 102, 103, 104. The structure needs to be implemented in three dimensions. This solution could be selected to increase the angular stroke and reduce the stiffness of the flexure pivot as the connecting rods 102, 103, 104 can be longer for a defined volume.

FIG. 4 illustrates the kinematics of a flexure pivot as in FIG. 2 with a total rotational symmetry of third order around the axis of rotation A. The center of mass of the structure corresponds to axis A making the flexure pivot strongly insensitive to gravity orientation. The kinematics has one degree of overconstraint. However, the degree of freedom of the pivot rotation is not local i.e., large angular strokes do not result in overstressing the structure.

FIG. 5 illustrates the kinematics of a flexure pivot as in FIG. 4, but where four connecting rods 202, 203, 204, 205 and four arms 206, 207, 208, 209 are used with a total rotational symmetry of fourth order around the axis of rotation A. The embodiment of FIG. 5 comprises a support 200 similar to the support 100 of the embodiments illustrated by FIGS. 2-4. It further comprises ideal hinges 210, 211, 212, 213 connecting the central assembly or the rigid body 201 to the peripheral assembly. The embodiment as illustrated by FIG. 5 further comprises coupling links 214, 215, 216, 217. As in the embodiment of FIGS. 2, 3 and 4, these coupling links are used to couple kinematically the rotation of the arms so as to avoid translational motions of the rigid body 201. One or two of the four coupling links 214, 215, 216, 217, if not in opposite position, can be removed and the translational motions of the rigid body 201 of the central assembly are still blocked, demonstrating kinematic redundancy. If four, three or two of the coupling links 214, 215, 216, 217 are used, the pivot has respectively two, one or zero degree of overconstraint. In all these cases, the degree of freedom of the pivot rotation remains not local.

FIG. 6 illustrates the kinematics of a pivot as in FIG. 2 but where the arms are placed arbitrarily around the axis of rotation A, i.e., without rotational symmetry. Components of FIG. 6 that are similar or identical to the corresponding components of FIG. 2 have the same reference numbers. Kinematically, the working principle of the coupling of the ideal third hinges 108, 109, 110 is still valid to obtain a theoretical zero parasitic shift of the axis of rotation A during the rotation of the pivot. This configuration allows to obtain a remote center of rotation. However, if implemented with flexure elements, the pivot will be less stiff in some radial directions and the parasitic shift will not be totally compensated, due to the lack of symmetry.

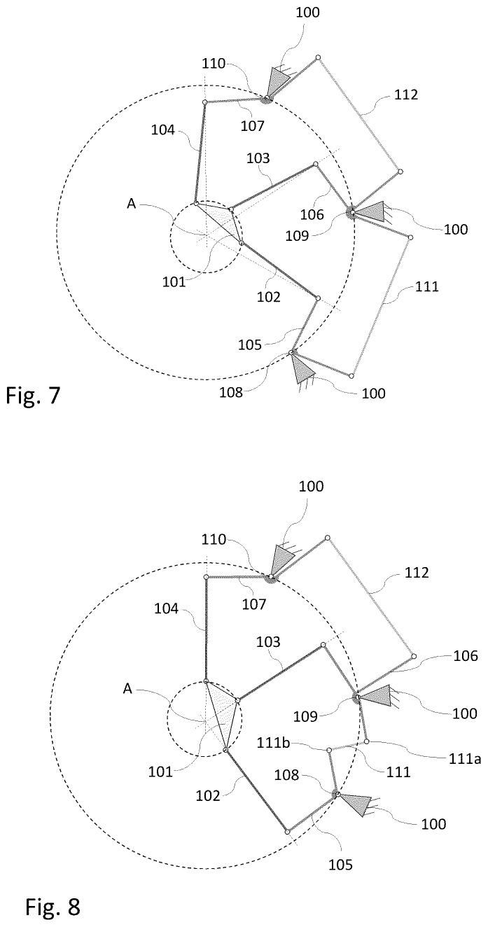

FIG. 7 illustrates the pivot of FIG. 6, after a rotation of the central assembly with regard to the peripheral assembly.

FIGS. 8 and 9 illustrate the kinematics of a pivot as in FIGS. 6 and 7 but where a third arm can be placed with a plane symmetry instead of rotational symmetry to another arm. The coupling principle to block the translational motions of the rigid body 101 is still valid if the coupling link 111 is placed such that the ideal hinges 108, 111b, 111a, 109 form now a Watt bar linkage instead of a parallelogram linkage. In a preferred configuration, the angles formed by the hinges 108, 111b, 111a and 111b, 111a, 109, should be equal to 90° at neutral position, such that the rotation amplitude of the ideal hinges 108 and 109 is equal in magnitude but with opposed direction. Note that the kinematics in FIGS. 7 and 9 could also be the rest position of the pivot, however, in this configuration, its stiffness and inertia would be less symmetrical with respect to the rotation direction.

FIG. 10 illustrates the kinematics of a pivot as in FIG. 5, but the four arms 206, 207, 208, 209 are placed with two planes of symmetry that contain the axis of rotation A and a rotational symmetry of order two. Due to these planes of symmetry, the pivot restoring torque magnitude becomes symmetrical with respect to the pivot rotation direction. The four coupling links 214, 215, 216, 217 form Watt bar linkages instead of parallelogram linkages used in the structure in FIG. 5. Since the orientation of the four coupling links 214, 215, 216, 217 are the only parts that break the two plane symmetries, the whole structure can be considered as pseudo symmetrical with two planes of symmetry. The kinematics has two degrees of overconstraint. Nevertheless, it has a theoretical zero parasitic shift of the axis of rotation A, thanks to its symmetry.

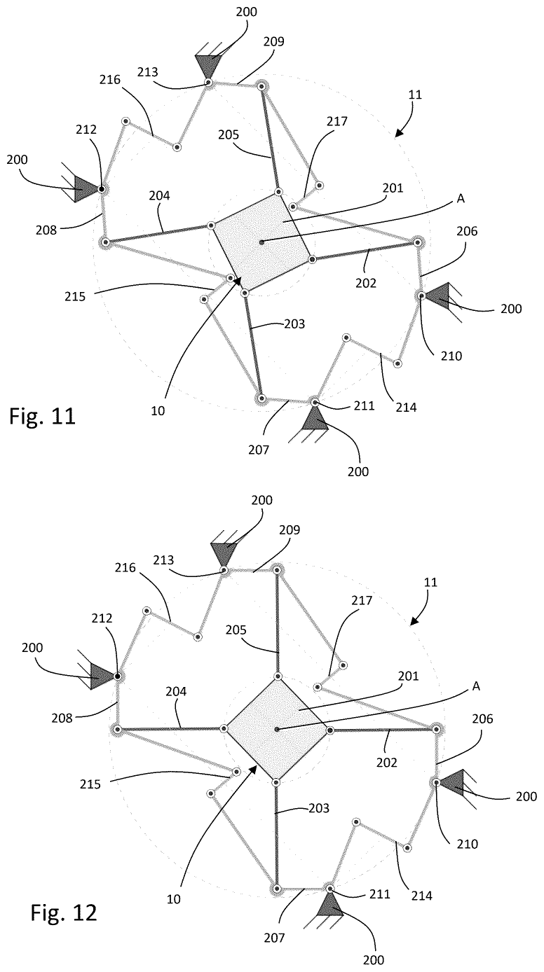

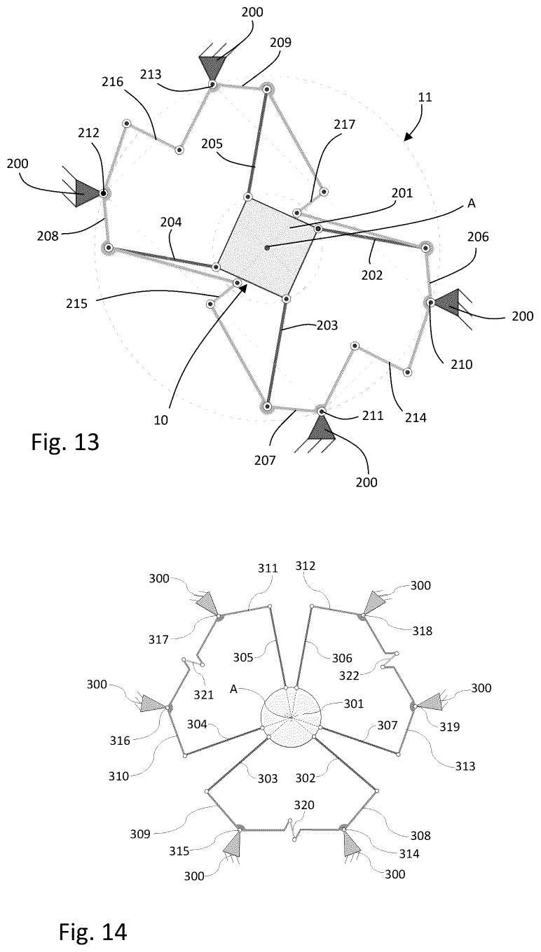

FIGS. 11, 12 and 13 illustrate the kinematics of a pivot similar to the pivot of FIG. 5. More specifically, FIG. 11 shows the pivot after a rotation of a first angle in a first direction with respect to the rest position; FIG. 12 illustrates the rest position of the pivot and FIG. 13 illustrates the pivot after a rotation of a second angle in a second direction, with respect to the rest position. The components of FIGS. 10-13 that are similar or identical to the corresponding components of FIG. 5 have the same reference numbers.

FIG. 14 illustrates the kinematics of a pivot with six connecting rods 302, 303, 302, 305, 306, 307 and six arms 308, 309, 310, 311, 312, 313, where the arms are not all directly connected to another. Only three coupling links 320, 321, 322 are used. The arms are placed such that the structure has three planes of pseudo-symmetry, the only dissymmetry comes from the orientation of the coupling links 320, 321, 322 that contain the axis of rotation A, and a rotational symmetry of order three around the axis of rotation A. As this structure is strongly symmetrical, it will lead to symmetrical behaviors of the restoring torque and the inertia variation of the flexure pivot. This kinematics has one degree of overconstraint but it has a theoretical zero parasitic shift of the axis of rotation A, thanks to its symmetry. A rigid body 301 is connected to a support 300 through the connecting rods 302, 303, 304, 305, 306, 307 and the arms 308, 309, 310, 311, 312, 313, these arms being linked to the support by ideal hinges 314, 315, 316, 317, 318, 319.

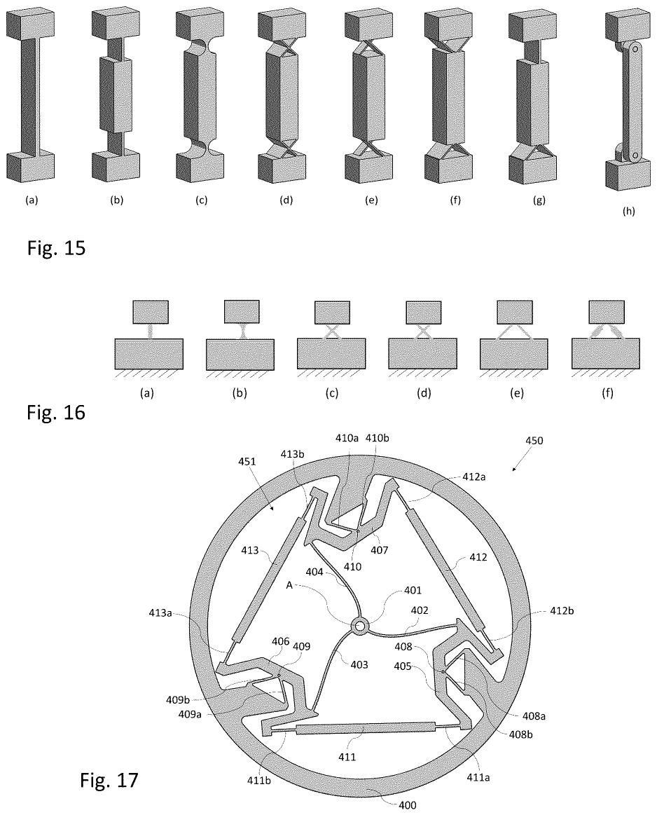

With reference to the description and more specifically to FIG. 15, a connecting rod as mentioned in the description is a kinematic chain connecting two rigid segments. Such a connecting rod can be implemented using ideal pivot joints or flexure elements. In the latter case, several kinds of flexure elements can be used: a flexure blade, two necked down flexure hinges connected by a rigid segment, two circular necked down flexures connected by a rigid segment, two unseparated crossed blades connected by a rigid segment, etc.

FIG. 15 shows different ways of concretely realizing the connecting rods 102, 103, 104; 202, 203, 204, 205; 302, 303, 304, 305, 306, 307 forming the primary links and the coupling links 111, 112, 214, 215, 216, 217; 320, 321, 322 or connecting elements using flexure elements. These rigid links with hinged extremities can for example take one of the following forms:
a flexure blade as illustrated by FIG. 15a
a rigid segment articulated at each of its two ends by a prismatic necked down flexure hinge, as illustrated by FIG. 15b
a rigid segment articulated at each of its two ends by a circular necked down flexure hinge, as illustrated by FIG. 15c
a rigid segment articulated at each of its two ends by two unseparated crossed blades, that is to say crossing in the same plane, as illustrated by FIG. 15d
a rigid segment articulated at each of its two ends by two separate crossed blades, i.e., crossing in two different planes, as illustrated by FIG. 15e
a rigid segment articulated at each of its two ends by a remote center of compliance pivot comprising two elastic blades which converge, as illustrated by FIG. 15f
a rigid segment articulated at one of its ends by an elastic neck and at its other end by a remote center of compliance pivot, as illustrated by FIG. 15g,
a rigid segment articulated at its both ends around a pin as illustrated by FIG. 15h; and
   more generally a rigid segment articulated in rotation at one of its ends by a first type of flexible or rotative joint and at its other end by a second type of flexible or rotative joint.

FIG. 16 shows different ways of concretely realizing the hinge 102a, 102b, 103a, 103b, 104a, 104b, 108, 109, 110; 111a, 111b, 112a, 112b, 210, 211, 212, 213; 314, 315, 316, 317, 318, 319 using flexure elements. These hinges can for example take one of the following forms:
a prismatic necked down flexure hinge as illustrated by FIG. 16a
a circular necked down flexure hinge as illustrated by FIG. 16b
two unseparated crossed blades as illustrated by FIG. 16c
two separate crossed blades as illustrated by FIG. 16d
a remote center of compliance pivot comprising two elastic blades which converge, as illustrated by FIG. 16e
two rigid links with hinged extremities as illustrated in FIG. 15 (see FIG. 16f).

Each flexure elements illustrated in FIGS. 15 and 16 produces, compared to the ideal joints illustrated in FIGS. 2 to 14, a restoring force or torque when deformed from neutral or rest position. The combination of all these restoring forces and torques defines the angular stiffness of the flexure pivot. Even if the flexure elements can have a parasitic shift when rotated as opposed to the ideal hinges as illustrated in FIGS. 2 to 14, the symmetry of the flexure implementation can cancel out the parasitic shift of the flexure pivot.

FIGS. 17-19 shows an example of concrete realization of a flexure pivot component 450 based on the principle of FIGS. 2 to 14 and more particularly of FIG. 4.

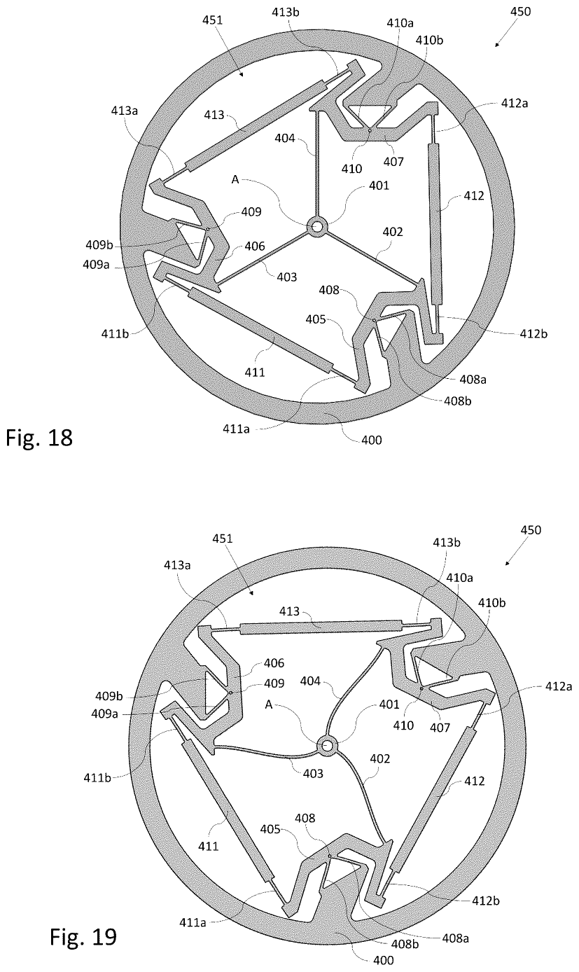

More specifically, FIG. 17 shows a flexure pivot component 450 comprising a fixed central assembly 401. The flexure pivot further comprises a peripheral assembly 400 able to rotate around the axis of rotation A. The flexure pivot component is illustrated by FIG. 17 after an anticlockwise rotation of the peripheral assembly 400 with regard to the fixed central assembly 401. FIG. 18 shows the flexure pivot component 450 in a rest position and FIG. 19 illustrates the flexure pivot component after a clockwise rotation.

This flexure pivot 450 comprises a fixed central assembly 401. The flexure pivot further comprises a peripheral assembly 400 able to rotate around the axis of rotation A. Connecting rods 402, 403, 404 and arms 405, 406, 407 kinematically connect the central assembly 401 to the peripheral assembly 400. More specifically, the central assembly 401 is connected to the arms by the three connecting rods 402, 403, 404 forming flexible connections, as illustrated on FIGS. 15a to 15h.

The peripheral assembly is connected to the three arms 405, 406, 407, pivoting around a pivoting point 408, 409, 410. The connection between the peripheral assembly 400 and the arms 405, 406, 407 is realized by flexure elements 408a, 408b, 409a, 409b, 410a, 410b forming flexible connections as illustrated by FIGS. 16a to 16f.

Each arm 405, 406, 407 comprises three connecting points. One of these connecting points enables the connection between the connecting rod 402, 403, 404 and the corresponding arm. The other connecting points enable connection between the arm and a connecting element called coupling link 411, 412, 413, said coupling link connecting two arms. These coupling links enable providing a higher radial stiffness of the flexure pivot as well as no parasitic shift of the axis of rotation. The connection between the arms 405, 406, 407 and the coupling links 411, 412, 413 is realized through hinges 411a, 411b, 412a, 412b, 413a, 413b.

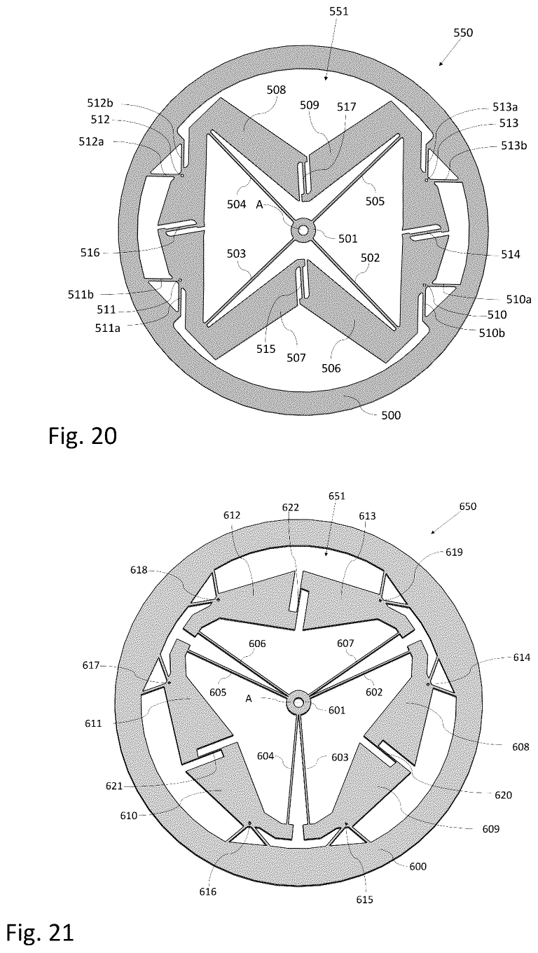

FIG. 20 shows an example of concrete realization of a flexure pivot component 550 based on the principle of FIGS. 2 to 14 and more particularly of the FIG. 10. Compared to the flexure pivot component 450 of FIGS. 17-19, the flexure pivot component 550 of FIG. 20 has a symmetrical restoring torque due to its two planes of pseudo-symmetry.

The components of the embodiment illustrated by FIG. 20 playing the same or a similar role then the components of the embodiment illustrated by FIGS. 5 and 10-13 have the same reference number, increased by 300.

FIG. 21 shows an example of concrete realization of a flexure pivot component 650 based on the principle of FIGS. 2 to 14 and more particularly of the FIG. 14. The components of the embodiment illustrated by FIG. 21 playing the same or a similar role then the components of the embodiment illustrated by FIG. 14 have the same reference number, increased by 300.

In FIGS. 17 to 21, the flexure pivot component 450; 550; 650 is intended to fulfill the function of a horological oscillator, but it could be an anchor, a rocker, a lever or other types of pivots.

It needs to be understood that in all the examples above, the functions of the central assembly and of the peripheral assembly or of the rotating rigid body and of the support can be inverted. Indeed, the rigid body 101; 201; 301 or the central assembly 401; 501; 601 could be the support, and the support 100; 200; 300 or peripheral assembly 400; 500; 600 could constitute the rotating part. In this case, as the peripheral assembly or outer part has relatively more inertia than the central assembly or inner part the peripheral assembly could be directly used as the balance. In the opposite case i.e., if the central assembly constitute the moving and the peripheral assembly constitutes the fixed part, a balance should be assembled to the central assembly or the rigid body, possibly in another plane and in another preferably dense material to obtain enough inertia.

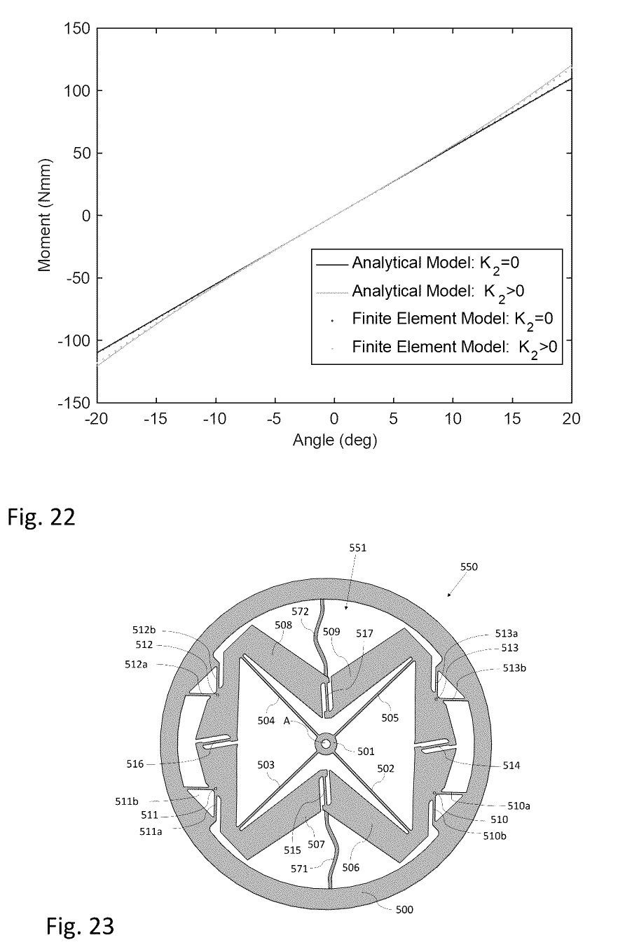

The restoring torque of the flexure pivot 451; 551; 651 can be linearized by adjusting the stiffness of the different flexure elements. Analytical model based on pseudo-rigid-body model PRBM and finite element model FEM both demonstrate the possibility to tune the pivot stiffness linearity. This is illustrated by FIG. 22. For example, the angular stiffness can be constant i.e., K2=0, where K2 is the value of the second order nonlinearity of the flexure pivot angular stiffness, or incremental with respect to the angle magnitude e.g., K2>0, to compensate potential escapement isochronism defect. Each of the mechanisms shown above has flexure elements whose bending stiffness affect the nonlinearity K2 of the overall flexure pivot stiffness without affecting its linear term K0. For example, in FIG. 20, the thickness and/or the length of flexure blades 510a, 510b, 511a, 511b, 512a, 512b, 513a, 513b can be adjusted to tune the isochronism defect without affecting the overall angular stiffness K0 i.e., the eigenfrequency. The same applies for the mechanisms shown in FIGS. 17-19 and 21.

The inertia of the flexure pivot component 450; 550; 650 can also be made constant with respect to the angular amplitude leading to a harmonic oscillator if K2=0 for specific mass arrangement and sizing of the rigid links.

There can be several mechanical stops to limit the rotation of the flexure pivot or to stop the amplitude of vibration modes.

The material constituting the structure of the flexure pivot can be chosen at least among silicon, metal, quartz, glass, metallic glass or polymer.

The eigenfrequencies of the flexure pivot components 450; 550; 650 were evaluated with FEM simulations and compared to prior art planar symmetrical flexure pivots EP3548973B1 and EP4047424A1. The same material and the same outer diameter are used to compare these flexure pivot oscillators. The central assembly forms the fixed part and the peripheral assembly is the rotating part. Compared to prior art, the ratio of the radial vibration frequency on the pivot natural oscillation frequency has been increased by a factor two, three and four with the flexure pivot components 450, 550 and 650, respectively. In terms of radial stiffness gain, this corresponds to a factor four, nine and sixteen with the flexure pivot components 450, 550 and 650, respectively, because the stiffness is proportional to the square of the corresponding eigenfrequency. The high radial stiffness of the flexure pivot component 450; 550; 650 advantageously:
reduces its gravity sensitivity i.e., less sag and less sensitivity to gravity orientation
reduces its sensitivity to linear acceleration, vibrations and shocks
allows to use a more massive balance to obtain lower oscillation frequency, thus fast, complex and energy-wasting escapements are not required

In order to modify the restoring torque of the flexure pivot 451; 551; 651, residual stresses could be added in the material of the flexure pivot components 450; 550; 650. For example, if the flexure pivot components 450; 550; 650 are made of a silicon, silicon dioxide films or silicon nitride films could be used to modify the stiffness of the flexure elements, which in turn can increase or decrease the oscillation frequency.

The adjustment of the restoring torque can also be made during the manufacturing of the flexure pivot, by applying a stress to the material forming said flexure pivot. It is further possible to calculate the individual stiffness of the different flexure elements, in order to obtain a final stiffness corresponding to the expected eigenfrequency and isochronism defect of the flexure pivot.

Another way to modify the restoring torque of the flexure pivot 451; 551; 651 could be to integrate one or more buckled beams between two rigid parts of the flexure pivot components, these rigid parts being possibly an arm 405, 406, 407; 506, 507, 508, 509; 608, 609, 610, 611, 612, 613, the peripheral assembly 400, 500, 600 or the central assembly 401, 501, 601. The buckled beams could be pre-buckled:
mechanically, i.e., the extremities of the buckled beams are moved closer.
by applying residual stresses in the material of the buckled beams.

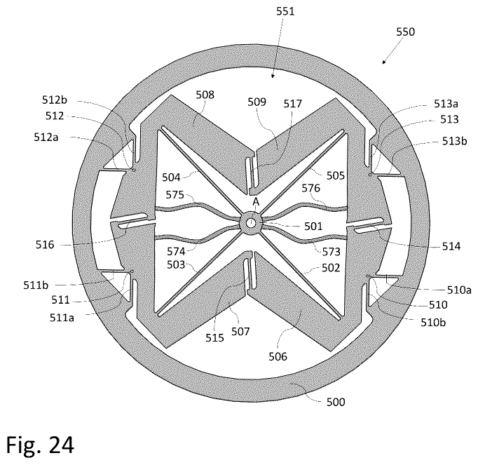

For example, FIG. 23 shows the flexure pivot component 550 as in FIG. 20, but with two added buckled beams 571, 572 that are attached to the rigid part 500 and to the intermediate rigid parts 506, 508. FIG. 24 shows a second configuration to modify the angular stiffness of the flexure pivot component 550, where four buckled beams 573, 574, 575, 576 are attached to the rigid part 501 and to the intermediate rigid parts 506, 507, 508, 509. In both examples, the rest position of the flexure pivot 551 is not modified, except if the negative angular stiffness due to the buckled beams is higher in magnitude than the positive angular stiffness of the flexure guidance. In the latter case, the total angular stiffness of the flexure pivot 551 is negative and the flexure pivot component 550 is thus angularly bistable. Note that a low positive angular stiffness of the flexure pivot 451; 551; 651 leads to an advantageous low oscillation frequency of the flexure pivot component 450; 550; 650 or allows to use a balance with a lower inertia for the same oscillation frequency. Other types of flexure elements could be assembled in series or in parallel to the flexure pivot component 450; 550; 650 to modify the stiffness of the flexure pivot 451; 551; 651.

The pivot of the invention, when realized under the form of a flexure pivot, i.e., with a restoring force, can be used as an oscillator or a timebase, in particular in a watch movement.

### LIST OF REFERENCES

Arms 105, 106, 107; 206, 207, 208, 209; 308, 309, 310, 311, 312, 313; 405, 406, 407
Buckled beams 571, 572, 573, 574, 575, 576
Central assembly 10; 401; 601
Component 550
Connecting rod 102, 103, 104; 202, 203, 204, 205; 302, 303, 304, 305, 306, 307; 402, 403, 404
Coupling links 111, 112; 214, 215, 216, 217; 320, 321, 322; 411, 412, 413
Flexure blades 510a, 510b, 511a, 511b, 512a, 512b, 513a, 513b
Flexure elements 408a, 408b, 409a, 409b, 410a, 410b
Flexure pivot component 450, 550, 650
Flexure pivot 551, 651
First hinge 102a, 103a, 104a
Second hinge 102b, 103b, 104b
Third ideal hinges 108, 109, 110
Hinges 108, 109, 110, 111a, 111b, 112a, 112b; 210, 211, 212, 213; 314, 315, 316, 317, 318, 319; 411a, 411b, 412a, 412b, 413a, 413b
Intermediate rigid parts 506, 507, 508, 509
Peripheral assembly 11; 400; 600
Pivoting point 408, 409, 410
Rigid body 101; 201; 301; 600, 601
Rigid parts 500, 501, 506, 507, 508, 509
Support 100; 200; 300

1. A pivot comprising two assemblies, namely a central assembly (10; 401; 501; 601) and a peripheral assembly (11; 400; 500; 600), these two assemblies being mobile in rotation relative to each other around an axis of rotation (A),
wherein the central assembly (10; 401; 501; 601) is kinematically connected to the peripheral assembly (11, 400, 500, 600) by at least three connecting rods (102, 103, 104; 202, 203, 204, 205; 302, 303, 304, 305, 306, 307; 402, 403, 404; 502, 503, 504, 505; 602, 603, 604, 605, 606, 607), said connecting rods being each connected to an arm (105, 106, 107; 206, 207, 208, 209;
308, 309, 310, 311, 312, 313; 405, 406, 407; 506, 507, 508, 509; 608, 609, 610, 611, 612, 613), the arms being connected to said peripheral assembly (11; 400; 500; 600) so that the arms can pivot around a pivoting point (108, 109, 110; 210, 211, 212, 213; 314, 315, 316, 317, 318, 319; 408, 409, 410; 510, 511, 512, 513; 614, 615, 616, 617, 618, 619), the connecting rods being connected to the arms in a location different from the pivoting point of said arm, and at least two pairs of arms are connected together by a coupling link (111, 112, 113; 214, 215, 216, 217; 320, 321, 322; 411, 412, 413; 514, 515, 516, 517; 620, 621, 622) in a location different from the pivoting point of said arms.

2. The pivot according to claim 1, wherein said connecting rods have a same length and a distance between the pivoting point of an arm and the point of connection between said arm and the corresponding connecting rod is the same for each couple connecting rod-arm.

3. The pivot according to claim 1, wherein said connecting rods comprise a rigid segment with a pivotable connection or a flexure element at each extremity.

4. The pivot according to claim 1, wherein said connecting rods comprise a flexure blade.

5. The pivot according to claim 1, wherein said arms are connected to the peripheral assembly by a pivotable connection or a flexure element.

6. The pivot according to claim 1, wherein the connecting rods extend radially with respect to the axis of rotation (A).

7. The pivot according to claim 5, wherein said flexure element between the arms and the peripheral assembly comprises two elastic blades arranged in two planes when the blades are in a rest position, and said planes intersecting on a line containing said pivot point.

8. The pivot according to claim 7, wherein the planes containing the blades are substantially perpendicular to each other.

9. The pivot according to claim 1, wherein the pivot has substantially a rotational symmetry of order N around the axis of rotation A, where N is the total number of arms or a ratio of the number of arms.

10. The pivot according to claim 1, wherein the pivot has substantially M planes of symmetry that contain the axis of rotation A, where M is the total number of arms or a ratio of the number of arms.

11. The pivot according to claim 1, wherein the pivot is planar.

12. The pivot according to claim 1, wherein the pivot is distributed in several planes.

13. The pivot according to claim 1, wherein said pivot further comprises at least one flexible torque adjusting element designed for modifying its restoring torque.

14. The according to claim 13, wherein said flexible torque adjusting element is a buckled beam (571, 572, 573, 574, 575, 576).

15. A process for manufacturing the pivot according to claim 1, wherein said manufacturing process comprises a step of applying a stress to the material forming said pivot in order to set a restoring torque of said pivot.

16. A process for manufacturing the pivot according to claim 1, wherein said manufacturing process comprises a step of calculating a stiffness of the flexure elements to obtain an expected isochronism of the flexure pivot.

17. An oscillator comprising the pivot according to claim 1.

18. The oscillator according to claim 17, wherein one of the assemblies among the central assembly and the peripheral assembly is fixed relative to a support on which said oscillator is mounted.

19. A watch movement characterized in that the watch movement comprises at least the oscillator according to claim 17.

20. A timepiece characterized in that the timepiece comprises at least one oscillator according to claim 17.
